(19) United States
(12) Patent Application Publication
(10) Pub. No.: US 2026/0211307 A1
(43) Pub. Date: Jul. 23, 2026

(54) ILLUMINATION SYSTEM AND PROJECTION DEVICE

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 19/428,263

(22) Filed: Dec. 21, 2025

(30) Foreign Application Priority Data
Jan. 21, 2025 (CN) 202510091032.5

(51) Int. Cl. G03B 21/20

(52) U.S. Cl. CPC G03B 21/204; G03B 21/2013; G03B 21/2066; G03B 21/208

(57) ABSTRACT

An illumination system includes a light source module, a light path switching component, and a wavelength conversion element. The light source module is configured to emit first, second, and third color lights. The first color light, transmitted in a first direction, has a polarization state. The second and third color lights are transmitted in a second direction. The light path switching component includes an electrically controlled element and an optical plate. The electrically controlled element is connected to the optical plate and configured to control a deflection thereof. When an incident angle of the first color light on the optical plate is greater than or equal to M degrees, the optical plate is configured to allow the first color light to pass through or reflect the first color light. The wavelength conversion element is disposed on a transmission path of the first color light. A projection device is also provided.

### CROSS-REFERENCE TO RELATED APPLICATION

This application claims the priority benefit of China application serial no. 202510091032.5, filed on January 21, 2025. The entirety of the above-mentioned patent application is hereby incorporated by reference herein and made a part of this specification.

### BACKGROUND

### Technical Field

The present disclosure relates to an optical system, and in particular to an illumination system and a projection device.

### Description of Related Art

With the advancement of projection technology, projection devices capable of projecting high-brightness images have been developed. Some projection devices use a laser light source in combination with a phosphor wheel (wavelength conversion wheel) as the source of an illumination beam. However, in projection devices that use a sequentially rotating phosphor wheel, the phosphor wheel’s response speed is relatively slow, which often leads to a color breaking phenomenon. That is, when the rotation speed of the phosphor wheel is low, the frequency of color switching per unit time is lower, causing the human eye to perceive a rainbow pattern. However, if the rotation speed of the phosphor wheel is increased to improve the color breaking issue, the noise generated by the phosphor wheel and its driving motor will become excessively high.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection device, which effectively suppress color breakup and laser speckle phenomena.

Other objectives and advantages of the disclosure may be further understood from the technical features disclosed.

To achieve one, some, or all of the above objectives or other objectives, an embodiment of the disclosure provides an illumination system, including a light source module, a light path switching component, and a wavelength conversion element. The light source module is configured to emit a first color light, a second color light, and a third color light. The first color light has a polarization state and is transmitted in a first direction. The second color light and the third color light are transmitted in a second direction. The first direction is different from the second direction. The light path switching component is disposed on a transmission path of the first color light. The light path switching component includes an electrically controlled element and an optical plate. The electrically controlled element is connected to the optical plate and is configured to control a deflection of the optical plate. When an incident angle of the first color light on the optical plate is greater than or equal to M degrees, the optical plate is configured to allow the first color light to pass through or configured to reflect the first color light. The wavelength conversion element is disposed on a transmission path of the first color light passing through the optical plate. The wavelength conversion element is configured to convert the first color light into a converted light beam.

To achieve one, some, or all of the above objectives or other objectives, an embodiment of the disclosure provides a projection device, including the aforementioned illumination system, a light valve, and a projection lens. The illumination system is configured to provide an illumination beam. The light valve is disposed on a transmission path of the illumination beam and is configured to convert the illumination beam into an image beam. The illumination beam includes at least one of the first color light, the converted light beam, the second color light, and the third color light. The projection lens is disposed on a transmission path of the image beam and is configured to project the image beam out of the projection device.

Based on the above, in the embodiments of the disclosure, the illumination system and the projection device have at least one of the following advantages. In the illumination system and the projection device in the embodiments of the disclosure, when the incident angle of the first color light on the optical plate is greater than or equal to M degrees, the optical plate is configured to allow the first color light to pass through or configured to reflect the first color light. Therefore, the illumination system and the projection device in the embodiments of the disclosure may switch the generation of the converted light beam by simply deflecting the optical plate. As a result, a shorter response time (i.e., faster switching) may be achieved, effectively suppressing the color breakup phenomenon.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic diagram of a light path of a projection device in a first timing according to an embodiment of the disclosure.

FIG. 1B is a schematic diagram of the light path of the projection device in FIG. 1A in a second timing.

FIG. 2A is a side view schematic diagram of the light source module in FIG. 1A viewed along a +x direction.

FIG. 2B is a cross-sectional schematic diagram of the light source module in FIG. 1A viewed along a +y direction.

FIGS. 3A to 3C are respectively side view schematic diagrams of the light path switching component in FIGS. 1A and 1B in three different states.

FIG. 4 is a front view schematic diagram of the wavelength conversion element in FIG. 1A viewed along the +x direction.

FIG. 5 is a graph showing a relationship between a reflectivity of the optical plate in FIGS. 1A and 1B and an incident angle of a light beam.

FIG. 6 is a timing diagram of the light source module in FIGS. 1A and 1B.

FIG. 7 is a side view schematic diagram of the light source module in another embodiment viewed along a -z direction.

FIGS. 8A to 8C are respectively side view schematic diagrams of the light path switching component in FIGS. 1A and 1B in another embodiment in three different states.

### DESCRIPTION IN THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

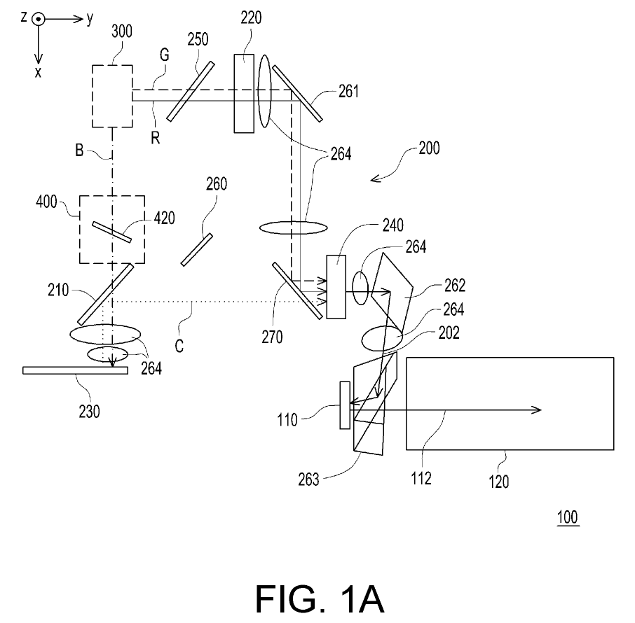

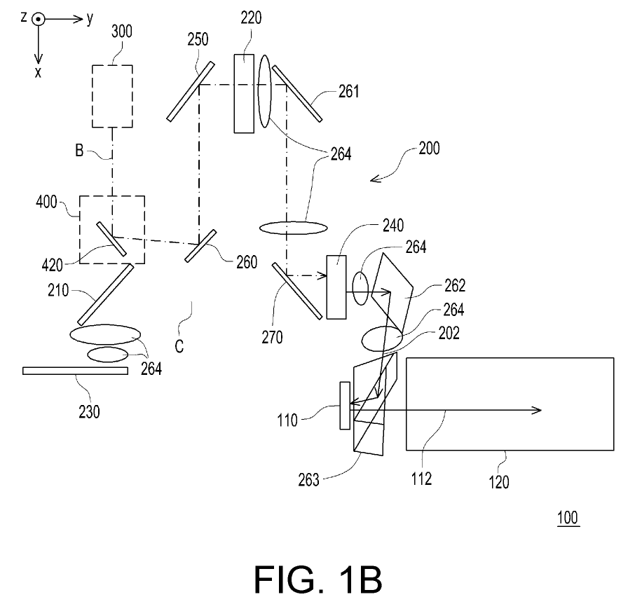

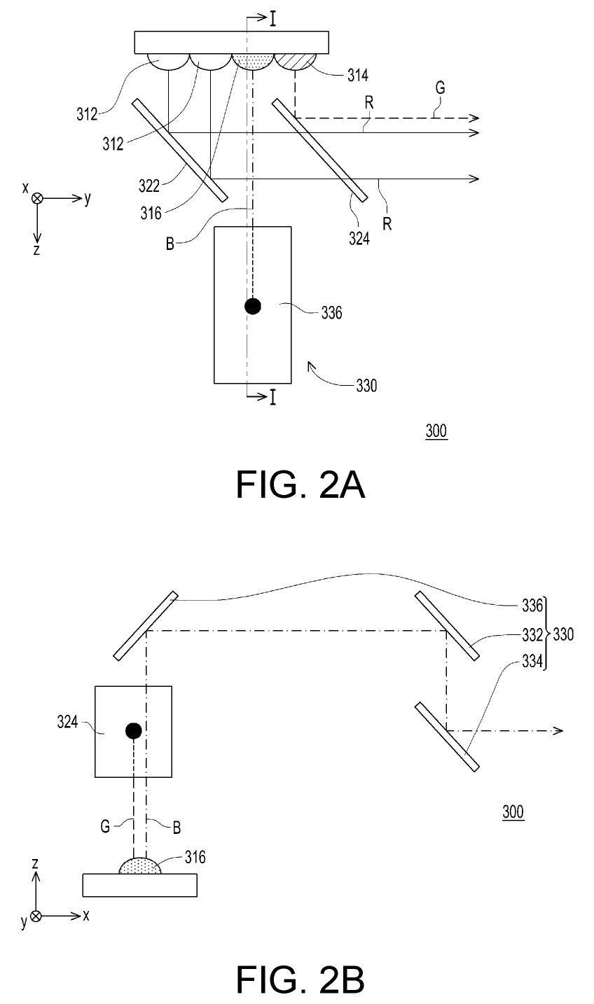

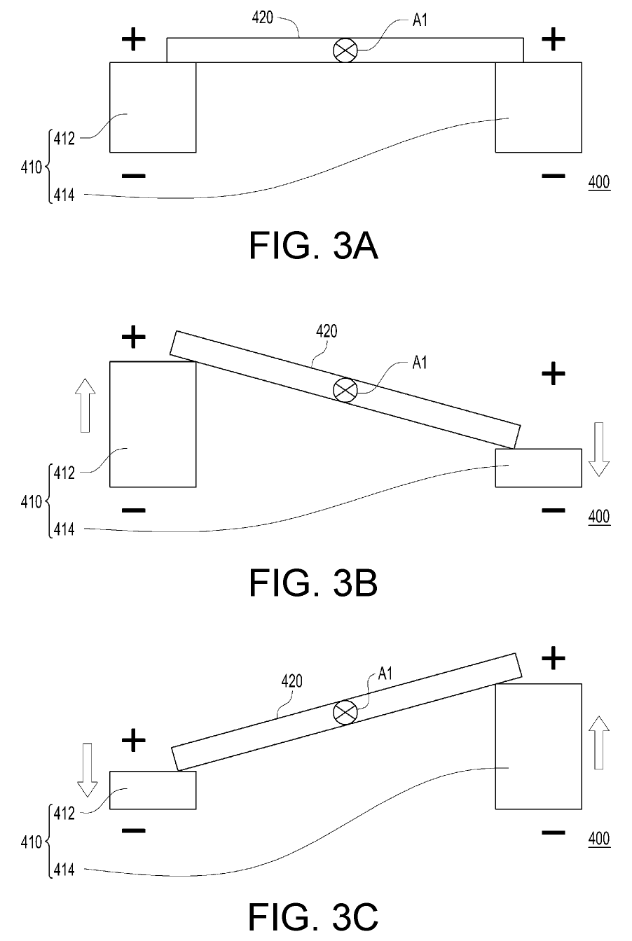

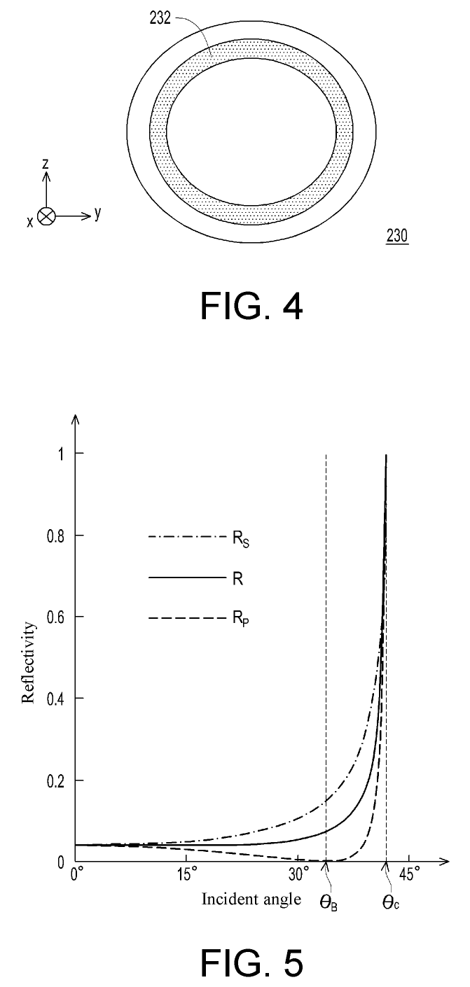

FIG. 1A is a schematic diagram of a light path of a projection device in a first timing according to an embodiment. FIG. 1B is a schematic diagram of the light path of the projection device in FIG. 1A in a second timing. FIG. 2A is a side view schematic diagram of the light source module of FIG. 1A viewed along the +x direction. To make the drawings concise and easy to understand, the second reflecting mirror and the third reflecting mirror of the guide assembly are omitted in FIG. 2A. FIG. 2B is a cross-sectional schematic diagram of the light source module of FIG. 1A viewed along the +y direction, which is a cross-sectional schematic diagram along the I-I line of FIG. 2A. FIGS. 3A to 3C are side view schematic diagrams of the light path switching component in three different states as shown in FIGS. 1A and 1B. FIG. 4 is a front view schematic diagram of the wavelength conversion element of FIG. 1A viewed along the +x direction. Referring to FIGS. 1A, 1B, 2A, 2B, 3A to 3C, and 4, a projection device 100 in this embodiment includes an illumination system 200, a light valve 110, and a projection lens 120. The illumination system 200 is configured to provide an illumination beam 202. The illumination system 200 includes a light source module 300, a light path switching component 400, and a wavelength conversion element 230. The light source module is configured to emit a first color light (for example, a blue light beam) B, a second color light (for example, a red light beam) R, and a third color light (for example, a green light beam) G. The first color light B has a polarization state. The first color light B from the light source module 300 is transmitted in a first direction (for example, the x direction in FIG. 1A). The second color light R and the third color light G are transmitted in a second direction (for example, the y direction in FIG. 1A). The first direction is different from the second direction.

In this embodiment, the light source module 300 includes at least one red light laser diode 312, at least one green light laser diode 314, and at least one blue light laser diode 316, which are located within the same package. In FIG. 2A, two (or two strings of) red light laser diodes 312, one (or one string of) green light laser diode(s) 314, and one (or one string of) blue light laser diode(s) 316 are used as an example. The blue light laser diode 316 is configured to emit the first color light B. The red light laser diode 312 is configured to emit the second color light R. The green light laser diode 314 is configured to emit the third color light G. In this embodiment, the light source module 300 further includes a reflecting element (such as a reflecting mirror) 322, a dichroic mirror 324, and a guide assembly 330. The reflecting element 322 and the dichroic mirror 324 are configured to guide the second color light R and the third color light G in the second direction (i.e., the +y direction). The dichroic mirror 324 is configured to allow the second color light R to pass through and reflect the third color light G. In this embodiment, the second color light R and the third color light G provided by the red light laser diode 312 and the green light laser diode 314 are transmitted in the +z direction. Then, the second color light R is reflected by the reflecting element 322 and transmitted in the +y direction to the dichroic mirror 324. The second color light R passes through the dichroic mirror 324 and continues to be transmitted in the +y direction. The third color light G, after being reflected by the dichroic mirror 324, is also transmitted in the +y direction.

The guide assembly 330 is configured to guide the first color light B in the first direction (i.e., the +x direction) (when leaving the light source module 300). The guide assembly 330 includes a first reflecting mirror 336, a second reflecting mirror 332, and a third reflecting mirror 334, which are sequentially disposed on the transmission path of the first color light B. As shown in FIGS. 2A and 2B, in the z direction, the height of the first reflecting mirror 336 and the second reflecting mirror 332 may be greater than the height of the third reflecting mirror 334. The height of the reflecting element 322 and the height of the dichroic mirror 324 may be the same. The height of the first reflecting mirror 336 and the second reflecting mirror 332 may be greater than the height of the reflecting element 322 and the dichroic mirror 324. The height of the reflecting element 322 and the dichroic mirror 324 may be equal to the height of the third reflecting mirror 334. The first color light B provided by the blue light laser diode 316 is transmitted in the +z direction. However, after being reflected by the first reflecting mirror 336, the first color light B is transmitted in the +x direction. At this time, the height of the first color light B in the z direction is different from the height of the second color light R and the third color light G in the z direction. Therefore, the second reflecting mirror 332 and the third reflecting mirror 334 are configured to shift the first color light B to the same height in the z direction as the second color light R and the third color light G. That is, the second reflecting mirror 332 is configured to reflect the first color light B from the first reflecting mirror 336 so that the first color light B is transmitted in the -z direction. The third reflecting mirror 334 is configured to reflect the first color light B from the second reflecting mirror 332 so that the first color light B is transmitted again in the +x direction. In this embodiment, the x direction, the y direction, and the z direction are perpendicular to each other.

The light path switching component 400 is disposed on the transmission path of the first color light B from the light source module 300. The light path switching component 400 includes an electrically controlled element 410 and an optical plate 420. The electrically controlled element 410 is connected to the optical plate 420, and the electrically controlled element 410 is configured to control the deflection of the optical plate 420. When the incident angle of the first color light B on the optical plate 420 (the angle between the first color light B and the normal of the optical plate 420) is greater than or equal to M degrees, the optical plate 420 is configured to allow the first color light B to pass through, or the optical plate 420 is configured to reflect the first color light B. The wavelength conversion element 230 is disposed on the transmission path of the first color light B that passes through the optical plate 420. The wavelength conversion element 230 is configured to convert the first color light B into a converted light beam C. In this embodiment, the converted light beam C is, for example, a yellow light beam. In other embodiments, the converted light beam C may also be the third color light G, the second color light R, or a combination thereof.

In this embodiment, the optical characteristics of the optical plate 420 may be such that when the incident angle of the first color light B on the optical plate 420 is greater than or equal to M degrees, the optical plate 420 is configured to allow the first color light B to pass through. When the incident angle is less than or equal to N degrees, the optical plate 420 is configured to reflect the first color light B. Alternatively, the optical characteristics of the optical plate 420 may also be such that when the incident angle of the first color light B on the optical plate 420 is greater than or equal to M degrees, the optical plate 420 is configured to reflect the first color light B, and when the incident angle is less than or equal to N degrees, the optical plate 420 is configured to allow the first color light B to pass through. The difference between M and N is greater than or equal to a value in a range of 5 degrees to 20 degrees. In this embodiment, the difference between M and N is, for example, greater than or equal to 10 degrees. Values of M and N may vary depending on the refractive index of the optical plate 420 and the polarization state of the first color light B. The optical plate 420 may be an optical glass plate. In other embodiments, the optical plate 420 may also be a plastic plate or a plate made of other transparent materials.

FIG. 5 is a graph showing the relationship between the reflectivity of the optical plate and the incident angle of the light beam in FIGS. 1A and 1B. In FIG. 5, the curve labeled R_{S} represents the reflectivity curve of S-polarized light relative to the optical plate 420. The curve labeled R_{P} represents the reflectivity curve of P-polarized light relative to the optical plate 420. The curve labeled R represents the reflectivity curve of non-polarized light relative to the optical plate 420. In this embodiment, the first color light B is a light beam with a P-polarization state (P-polarized light). A Brewster’s angle θ_{B} of the first color light B is approximately 30 to 35 degrees (e.g., 32 degrees), and a critical angle θ_{c} is, for example, 40 to 45 degrees (e.g., 42 degrees). Therefore, in this embodiment, the range of the M value may be 40 to 45 degrees (e.g., M value is 42 degrees), and the range of the N value may be 30 to 35 degrees (e.g., N value is 32 degrees). When the incident angle of the first color light B relative to the optical plate 420 is less than or equal to N degrees, for example, when the incident angle is near the Brewster’s angle (30 to 35 degrees), the reflectivity is very low. Thus, the first color light B passes through the optical plate 420 and is transmitted to the wavelength conversion element 230. When the incident angle of the first color light B on the optical plate 420 is greater than or equal to M degrees, the incident angle is greater than or equal to the critical angle. In this case, the first color light B is totally reflected by the optical plate 420 and is not transmitted to the wavelength conversion element 230. By controlling the deflection of the optical plate 420 through the electrically controlled element 410, the optical plate 420 may switch between the deflection states shown in FIGS. 3B and 3C. This enables switching between an incident angle of less than or equal to N degrees (as in the state of FIG. 1A) and an incident angle of greater than or equal to M degrees (as in the state of FIG. 1B). As a result, switching may be achieved between the state in which the first color light B is transmitted to the wavelength conversion element 230 (as in the state of FIG. 1A) and the state in which the first color light B is not transmitted to the wavelength conversion element 230 (as in the state of FIG. 1B).

In other embodiments, by coating the surface of the optical plate 420 with an interference film, the optical plate 420 may be configured to reflect the first color light B when the incident angle of the first color light B on the optical plate 420 is less than or equal to N degrees, and to allow the first color light B to pass through when the incident angle is greater than or equal to M degrees.

In this embodiment, the electrically controlled element 410 includes a first component 412 and a second component 414, which are respectively disposed at opposite ends of the optical plate 420. The first component 412 and the second component 414 are configured to receive different electrical characteristics, respectively. In this embodiment, the first component 412 includes a first piezoelectric crystal, and the second component 414 includes a second piezoelectric crystal. The first piezoelectric crystal and the second piezoelectric crystal are configured to respectively receive one of a first voltage and a second voltage and the other of the first voltage and the second voltage, such that one of the first piezoelectric crystal and the second piezoelectric crystal is stretched, and the other of the first piezoelectric crystal and the second piezoelectric crystal is compressed, thereby causing a deflection of the optical plate 420. The first voltage and the second voltage, for example, are electrically opposite voltages. One of the first voltage and the second voltage is a positive voltage, and the other of the first voltage and the second voltage is a negative voltage. In FIG. 3A, no voltage is applied to either the first component 412 or the second component 414. Therefore, the heights of the first component 412 and the second component 414 are the same, and the optical plate 420 is parallel to the wavelength conversion element 230. In FIG. 3B, the first component 412 is stretched when the first voltage (e.g., a positive voltage) is applied thereto. The first component 412 lifts one end of the optical plate 420 (the left side in FIG. 3B) upward. The second component 414 is compressed when the second voltage (e.g., a negative voltage) is applied thereto. The second component 414 moves the other end of the optical plate 420 (the right side in FIG. 3B) downward. As a result, the optical plate 420 deflects in a clockwise direction in FIG. 3B. In FIG. 3C, the first component 412 is compressed when the second voltage is applied thereto, and the second component 414 is stretched when the first voltage is applied thereto. As a result, the optical plate 420 deflects in a counterclockwise direction in FIG. 3C. In this embodiment, the material of the first piezoelectric crystal and the second piezoelectric crystal may include BaTiO₃, KNbO₃, SiO₂, or KH₂PO₄. The light path switching component 400 in this embodiment uses piezoelectric crystals, which have a fast response speed, as the material of the electrically controlled element 410. This causes the deflection angle of the optical plate 420 to be quickly switched, changing the transmission path of the first color light B at different timings. As a result, in the optical configuration where the illumination beam 202 of the illumination system 200 is sourced from the light source module 300 in combination with the wavelength conversion element 230, flicker and color breaking phenomena may be avoided, thereby providing better image quality.

In this embodiment, the optical plate 420 deflects around an axis A1, and the axis A1 is parallel to the wavelength conversion element 230. In an embodiment, the maximum swing angle difference of the optical plate 420 (e.g., the angle difference between FIGS. 3B and 3C) is greater than or equal to a value in a range of 2 degrees to 10 degrees. In this embodiment, the maximum swing angle difference of the optical plate 420 is, for example, greater than or equal to 5 degrees.

In this embodiment, the wavelength conversion element 230 is a rotating wheel with a phosphor 232 (such as a phosphor wheel). Since the illumination system 200 controls whether the first color light B is transmitted to the wavelength conversion element 230 through the light path switching component 400, the phosphor 232 may be arranged as a completely continuous ring on the surface of the rotating wheel (annular phosphor). The first color light B transmitted to the wavelength conversion element 230 illuminates the phosphor 232, and the rotation speed of the rotating wheel is not restricted. As a result, the noise of the rotating wheel may be effectively suppressed. In another embodiment, the wavelength conversion element 230 may also be a fixed element with phosphor. In this embodiment, the phosphor 232 is, for example, yellow phosphor. In other embodiments, the phosphor 232 may also be red phosphor, green phosphor, or a combination thereof. In this embodiment, by configuring the wavelength conversion element 230, compared with an illumination system that uses only laser as a light source, higher brightness is achieved (brightness is not limited by the packaged light source), and the issue of laser speckle is effectively resolved.

In this embodiment, the illumination system 200 further includes a first beam-splitting element 210, which is located between the wavelength conversion element 230 and the light path switching component 400. The first beam-splitting element 210 is configured to allow the first color light B from the light path switching component 400 to pass through and to reflect the converted light beam C from the wavelength conversion element 230.

In this embodiment, the illumination system 200 further includes a first light homogenizing element 220 and a second light homogenizing element 240. The first light homogenizing element 220 is disposed on the transmission paths of the first color light B from the light path switching component 400, the second color light R from the light source module 300, and the third color light G from the light source module 300. The second light homogenizing element 240 is disposed on the transmission paths of the first color light B, the second color light R, and the third color light G from the first light homogenizing element 220, as well as the converted light beam C from the wavelength conversion element 230. Each of the first light homogenizing element 220 and the second light homogenizing element 240 is, for example, a lens array, an integration rod, or another optical element with a light homogenization effect. In this embodiment, the first light homogenizing element 220 and the second light homogenizing element 240 are, for example, lens arrays. The first light homogenizing element 220 is configured to solve the issue of laser speckle. The second light homogenizing element 240 is configured to adjust the light shape of the first color light B, the second color light R, the third color light G, and the converted light beam C to match the shape of the light entrance surface of the light valve 110 (e.g., rectangle). In other embodiments, the illumination system 200 may include only a single light homogenizing element disposed on the transmission paths of the first color light B, the second color light R, the third color light G, and the converted light beam C.

In this embodiment, the illumination system 200 further includes a second beam-splitting element 250, which is disposed between the light source module 300 and the first light homogenizing element 220. The second beam-splitting element 250 is configured to reflect the first color light B and to allow the second color light R and the third color light G to pass through, so that the first color light B reflected by the light path switching component 400, as well as the second color light R and the third color light G from the light source module 300, are all transmitted to the first light homogenizing element 220. In this embodiment, the illumination system 200 further includes a reflecting mirror 260, which is disposed between the light path switching component 400 and the second beam-splitting element 250. The reflecting mirror 260 is configured to reflect the first color light B reflected by the light path switching component 400 to the second beam-splitting element 250. In this embodiment, the illumination system 200 further includes a third beam-splitting element 270, which is disposed between the first beam-splitting element 210 and the second light homogenizing element 240. The third beam-splitting element 270 is configured to allow the converted light beam C from the first beam-splitting element 210 to pass through and be transmitted to the second light homogenizing element 240, and to reflect the first color light B, the second color light R, and the third color light G from the first light homogenizing element 220. In this embodiment, the first beam-splitting element 210, the second beam-splitting element 250, and the third beam-splitting element 270 are, for example, dichroic mirrors.

The light valve 110 is disposed on the transmission path of the illumination beam 202 and is configured to convert the illumination beam 202 into an image beam 112. The illumination beam 202 includes at least one of the first color light B, the converted light beam C, the second color light R, and the third color light G from the second light homogenizing element 240. The projection lens 120 is disposed on the transmission path of the image beam 112 and is configured to project the image beam 112 out of the projection device 100 to form a projected image.

In this embodiment, the illumination system 200 may include a reflecting mirror 261, which is configured to reflect the first color light B, the second color light R, and the third color light G from the first light homogenizing element 220 to the third beam-splitting element 270. The illumination beam 202 from the second light homogenizing element 240 may be reflected by a reflecting mirror 262 to an internal total reflection prism 263 and then transmitted to the light valve 110 via the internal total reflection prism 263. The light valve 110 may be a digital micro-mirror device (DMD), a liquid-crystal-on-silicon (LCOS) panel, or another suitable spatial light modulator, which modulates the illumination beam 202 into the image beam 112. The image beam 112 is then transmitted to the projection lens 120 via the internal total reflection prism 263. On the various light paths of the illumination system 200 in this embodiment, lenses 264 may be appropriately arranged to improve the transmission quality of each light beam. The projection lens 120 may include a combination of one or more optical lenses with refractive power, such as a combination of non-planar lenses including biconcave lenses, biconvex lenses, concave-convex lenses, convex-concave lenses, plano-convex lenses, and plano-concave lenses. In an embodiment, the projection lens 120 may also include an optical reflecting lens, which reflects the image beam 112 from the light valve 110 and projects it onto a projection target. The present disclosure does not impose limitations on the structure or types of the projection lens 120.

In the illumination system 200 and the projection device 100 of this embodiment, the deflection of the structurally simple optical plate 420 may be controlled to switch whether the first color light B is transmitted to the wavelength conversion element 230. This controls whether the converted light beam C is generated at different timings. As a result, a shorter response time (i.e., faster switching) may be achieved, effectively suppressing the color breaking phenomenon. In an embodiment, the switching frequency of the electrically controlled element 410 of the light path switching component 400 may correspond to the response speed of a processor (not shown) of the projection device 100. The switching frequency of the electrically controlled element 410 may be greater than or equal to 30 Hz, and may also be implemented at a higher switching frequency such as greater than or equal to 60 Hz. This effectively suppresses the color breaking phenomenon. Since piezoelectric crystals are high-speed response components, achieving the required switching frequency is easy, and the deflection of the optical plate 420 is less likely to generate noise.

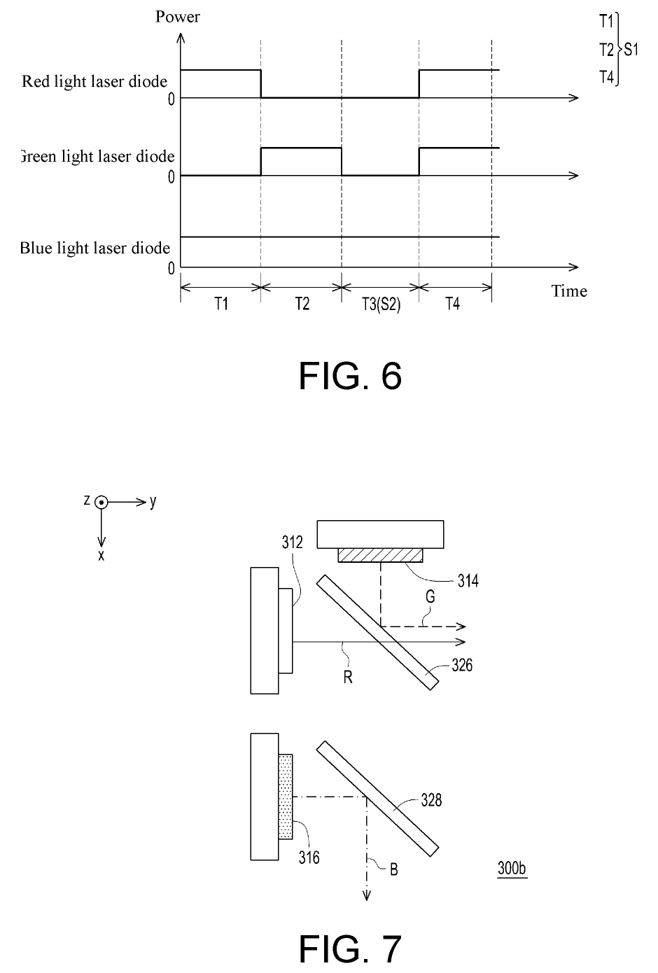

FIG. 6 is a timing diagram of the light source module in FIGS. 1A and 1B. Referring to FIGS. 1A, 1B, and 6, FIG. 6 shows the output power of the red light laser diode 312, the green light laser diode 314, and the blue light laser diode 316 over time. In this embodiment, at a first timing S1 (i.e., in time intervals T1, T2, and T4), the electrically controlled element 410 of the light path switching component 400 is configured to control the deflection angle of the optical plate 420 so as to allow the first color light B from the light source module 300 to pass through the optical plate 420 and to be incident on the wavelength conversion element 230 (as shown in FIG. 1A). At a second timing S2 (i.e., in a time interval T3), the electrically controlled element 410 of the light path switching component 400 is configured to control the deflection angle of the optical plate 420, so that the first color light B from the light source module 300 is reflected by the optical plate 420 and is not incident on the wavelength conversion element 230 (as shown in FIG. 1B), causing the first color light B to be transmitted to the reflecting mirror 260. In this embodiment, during the time interval T1, the red light laser diode 312 and the blue light laser diode 316 are turned on simultaneously, while the green light laser diode 314 is turned off. At this time, the second color light R and the converted light beam C are transmitted to the second light homogenizing element 240. During the time interval T2, the green light laser diode 314 and the blue light laser diode 316 are turned on simultaneously, while the red light laser diode 312 is turned off. At this time, the third color light G and the converted light beam C are transmitted to the second light homogenizing element 240. During the time interval T3, the blue light laser diode 316 is turned on, and the first color light B is transmitted to the second light homogenizing element 240. During the time interval T4, the red light laser diode 312, the green light laser diode 314, and the blue light laser diode 316 are all turned on simultaneously. At this time, the second color light R, the third color light G, and the converted light beam C are transmitted to the second light homogenizing element 240. The time intervals T1, T2, T3, and T4 may sequentially and repeatedly appear over time. The order in which the time intervals T1, T2, T3, and T4 appear is not limited to what is shown in FIG. 6 and may follow any possible sequence.

In another embodiment, the red light laser diode 312 and the green light laser diode 314 may be turned on at the same time at the first timing S1 (i.e., in the time intervals T1, T2, and T4) to simultaneously emit the second color light R and the third color light G , and are turned off only at the second timing S2.

FIG. 7 is a side view schematic diagram of another embodiment of the light source module, viewed along the -z direction. Referring to FIG. 7, a light source module 300b in this embodiment may be used to replace the light source module 300 in FIGS. 2A and 2B. The light source module 300b in this embodiment is similar to the light source module 300 in FIGS. 2A and 2B, with the main differences described as follows. In the light source module 300b in this embodiment, the red light laser diode 312, the green light laser diode 314, and the blue light laser diode 316 are located in different packages. In this embodiment, the light source module 300b includes a dichroic mirror 326 and a reflecting mirror 328. The dichroic mirror 326 is disposed on the transmission path of the second color light R from the red light laser diode 312 and the third color light G from the green light laser diode 314. The dichroic mirror 326 is configured to guide (e.g., to combine the light paths of) the second color light R and the third color light G, so that the second color light R and the third color light G are transmitted in the second direction (i.e., the +y direction) to the second beam-splitting element 250. In this embodiment, the red light laser diode 312 emits the second color light R in the +y direction. The second color light R then passes through the dichroic mirror 326 and continues to be transmitted in the +y direction. The green light laser diode 314 emits the third color light G in the +x direction. The dichroic mirror 326 then reflects the third color light G, directing the third color light G to be transmitted in the +y direction. In another embodiment, the dichroic mirror 326 may also be configured to reflect the second color light R while allowing the third color light G to pass through, and the positions of the red light laser diode 312 and the green light laser diode 314 may be interchanged.

The reflecting mirror 328 is disposed on the transmission path of the first color light B from the blue light laser diode 316 and is configured to reflect the first color light B, directing the first color light B to be transmitted in the first direction (i.e., the +x direction). In this embodiment, the blue light laser diode 316 emits the first color light B in the +y direction. The reflecting mirror 328 then reflects the first color light B, directing the first color light B to be transmitted in the +x direction.

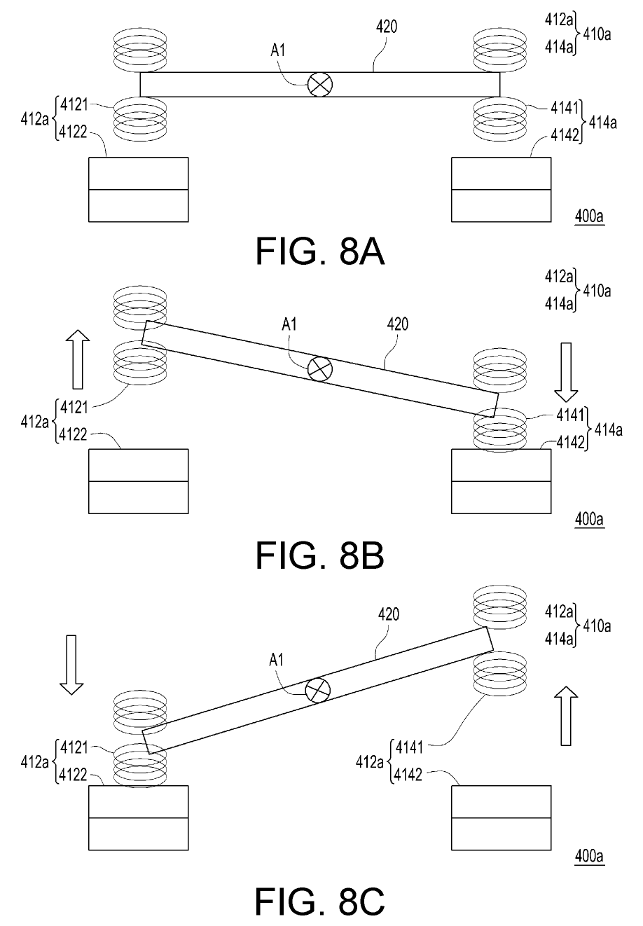

FIGS. 8A to 8C are side view schematic diagrams of another embodiment of the light path switching component in three different states, corresponding to FIGS. 1A and 1B. Referring to FIGS. 1A, 1B, and 8A to 8C, a light path switching component 400a in this embodiment is similar to the light path switching component 400 in FIGS. 3A to 3C, with the main difference being an electrically controlled element 410a. In the light path switching component 400a in this embodiment, the electrically controlled element 410a includes a first component 412a and a second component 414a, which are respectively disposed at opposite ends of the optical plate 420. The first component 412a includes at least one first coil 4121 and a first fixed magnet (permanent magnet) 4122. The second component 414a includes at least one second coil 4141 and a second fixed magnet (permanent magnet) 4142. The first coil 4121 and the second coil 4141 are configured to receive an electric current, such that one of a repulsive force and an attractive force is generated between the first coil 4121 and the first fixed magnet 4122, and the other of a repulsive force and an attractive force is generated between the second coil 4141 and the second fixed magnet 4142. This causes the optical plate 420 to deflect. For example, in FIG. 8A, no electric current is applied to the first coil 4121 or the second coil 4141. At this time, no magnetic repulsive force or magnetic attractive force is generated between the first coil 4121 and the first fixed magnet 4122, and no magnetic repulsive force or magnetic attractive force is generated between the second coil 4141 and the second fixed magnet 4142. The heights of the first coil 4121 and the second coil 4141 are the same, and the optical plate 420 is parallel to the wavelength conversion element 230. In FIG. 8B, electric current is applied to both the first coil 4121 and the second coil 4141. At this time, a magnetic repulsive force is generated between the first coil 4121 and the first fixed magnet 4122. The first component 412a drives one end of the optical plate 420 (the left side in FIG. 8B) upward. A magnetic attractive force is generated between the second coil 4141 and the second fixed magnet 4142. The second component 414a drives the other end of the optical plate 420 (the right side in FIG. 8B) downward, causing the optical plate 420 to deflect in a clockwise direction around axis A1. In FIG. 8C, electric current is applied to the first coil 4121 and the second coil 4141 in a direction opposite to that in FIG. 8B. At this time, a magnetic attractive force is generated between the first coil 4121 and the first fixed magnet 4122, while a magnetic repulsive force is generated between the second coil 4141 and the second fixed magnet 4142. This causes the optical plate 420 to deflect in a counterclockwise direction around axis A1. For example, when the N poles of the first fixed magnet 4122 and the second fixed magnet 4142 face the same direction, the first coil 4121 and the second coil 4141 receive electric currents in opposite directions. For example, the first coil 4121 receives a positive current, while the second coil 4141 receives a negative current. When the N poles of the first fixed magnet 4122 and the second fixed magnet 4142 face different directions, the first coil 4121 and the second coil 4141 receive electric currents in the same direction. For example, both the first coil 4121 and the second coil 4141 receive positive current. In another embodiment, the first fixed magnet 4122 and the second fixed magnet 4142 may be replaced with coils.

The light path switching component 400 in this embodiment uses coils with a fast response speed as the components of the electrically controlled element 410. This causes the deflection angle of the optical plate 420 to be quickly switched, changing the transmission path of the first color light B at different timings. As a result, in the optical configuration where the illumination beam 202 of the illumination system 200 is sourced from the light source module 300 in combination with the wavelength conversion element 230, flicker and color breaking phenomena may be avoided, thereby providing better image quality.

In summary, the illumination system and the projection device in the embodiments of the present disclosure have at least one of the following advantages. In the illumination system and the projection device in the embodiments, when the incident angle of the first color light on the optical plate is greater than or equal to M degrees, the optical plate is configured to allow the first color light to pass through or to reflect the first color light. Therefore, the illumination system and the projection device in the embodiments may switch whether the converted light beam is generated simply by deflecting the optical plate. As a result, a shorter response time (i.e., faster switching) may be achieved, effectively suppressing the color breaking phenomenon. The deflection of the optical plate is less likely to generate noise, and the use of the wavelength conversion element may also effectively suppress speckle phenomena.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will cause a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a light source module, configured to emit a first color light, a second color light, and a third color light, wherein the first color light has a polarization state, the first color light is transmitted in a first direction, the second color light and the third color light are transmitted in a second direction, and the first direction is different from the second direction;
a light path switching component, disposed on a transmission path of the first color light, the light path switching component comprising an electrically controlled element and an optical plate, wherein the electrically controlled element is connected to the optical plate, the electrically controlled element is configured to control a deflection of the optical plate, and when an incident angle of the first color light on the optical plate is greater than or equal to M degrees, the optical plate is configured to allow the first color light to pass through or configured to reflect the first color light; and
a wavelength conversion element, disposed on the transmission path of the first color light passing through the optical plate, wherein the wavelength conversion element is configured to convert the first color light into a converted light beam.

2. The illumination system according to claim 1, wherein in a first timing, the first color light passes through the optical plate and is incident on the wavelength conversion element, and in a second timing, the first color light is reflected by the optical plate and does not become incident on the wavelength conversion element.

3. The illumination system according to claim 1, wherein when the incident angle of the first color light on the optical plate is greater than or equal to M degrees, the optical plate is configured to allow the first color light to pass through, and when the incident angle is less than or equal to N degrees, the optical plate is configured to reflect the first color light, or when the incident angle of the first color light on the optical plate is greater than or equal to M degrees, the optical plate is configured to reflect the first color light, and when the incident angle is less than or equal to N degrees, the optical plate is configured to allow the first color light to pass through.

4. The illumination system according to claim 3, wherein a difference between M and N is greater than or equal to a value in a range of 5 degrees to 20 degrees.

5. The illumination system according to claim 1, wherein the wavelength conversion element is a fixed element having a phosphor or a rotating wheel having the phosphor.

6. The illumination system according to claim 1, wherein the electrically controlled element comprises a first assembly and a second assembly, respectively disposed at two opposite ends of the optical plate, wherein the first assembly and the second assembly are configured to respectively receive different electrical characteristics.

7. The illumination system according to claim 6, wherein the first assembly comprises a first piezoelectric crystal, the second assembly comprises a second piezoelectric crystal, the first piezoelectric crystal and the second piezoelectric crystal being configured to respectively receive one of a first voltage and a second voltage and another one of the first voltage and the second voltage, such that one of the first piezoelectric crystal and the second piezoelectric crystal is stretched and another one of the first piezoelectric crystal and the second piezoelectric crystal is compressed, thereby causing a deflection of the optical plate.

8. The illumination system according to claim 7, wherein a material of the first piezoelectric crystal and the second piezoelectric crystal comprises BaTiO₃, KNbO₃, SiO₂, or KH₂PO₄.

9. The illumination system according to claim 1, wherein the electrically controlled element comprises a first assembly and a second assembly, respectively disposed at two opposite ends of the optical plate, the first assembly comprising a first coil and a first fixed magnet, the second assembly comprising a second coil and a second fixed magnet, wherein the first coil and the second coil are configured to receive a current, such that one of a repulsive force and an attractive force is generated between the first coil and the first fixed magnet, and the other one of the repulsive force and the attractive force is generated between the second coil and the second fixed magnet.

10. The illumination system according to claim 1, wherein the optical plate is deflected around an axis, and the axis is parallel to the wavelength conversion element.

11. The illumination system according to claim 1, wherein a maximum swing angle difference of the optical plate is greater than or equal to a value in a range of 2 degrees to 10 degrees.

12. The illumination system according to claim 1, further comprising a first light splitting element, located between the wavelength conversion element and the light path switching component, wherein the first light splitting element is configured to allow the first color light to pass through and configured to reflect the converted light beam.

13. The illumination system according to claim 1, further comprising a first light homogenizing element and a second light homogenizing element, wherein the first light homogenizing element is disposed on a transmission path of the first color light, the second color light, and the third color light, and the second light homogenizing element is disposed on a transmission path of the first color light, the second color light, the third color light, and the converted light beam.

14. The illumination system according to claim 13, further comprising a second light splitting element, configured to reflect the first color light and allow the second color light and the third color light to pass through, such that the first color light reflected by the light path switching component and the second color light and the third color light from the light source module are all transmitted to the first light homogenizing element.

15. The illumination system according to claim 1, wherein a switching frequency of the electrically controlled element is greater than or equal to 30 Hz.

16. The illumination system according to claim 1, wherein the light source module comprises:
a red light laser diode, a green light laser diode, and a blue light laser diode located in a same package, wherein the blue light laser diode is configured to emit the first color light, the red light laser diode is configured to emit the second color light, and the green light laser diode is configured to emit the third color light;
a reflecting element and a dichroic mirror, configured to guide the second color light and the third color light in the second direction; and
a guide assembly, configured to guide the first color light in the first direction.

17. The illumination system according to claim 1, wherein the light source module comprises:
a red light laser diode, configured to emit the second color light;
a green light laser diode, configured to emit the third color light;
a blue light laser diode, configured to emit the first color light;
a dichroic mirror, configured to guide the second color light and the third color light in the second direction; and
a reflecting mirror, configured to reflect the first color light toward the first direction, wherein the red light laser diode, the green light laser diode, and the blue light laser diode are respectively located in different packages.

18. A projection device, comprising:
an illumination system, configured to provide an illumination beam, the illumination system comprising:
a light source module, configured to emit a first color light, a second color light, and a third color light, wherein the first color light has a polarization state, the first color light is transmitted in a first direction, the second color light and the third color light are transmitted in a second direction, and the first direction is different from the second direction;
a light path switching component, disposed on a transmission path of the first color light, the light path switching component comprising an electrically controlled element and an optical plate, wherein the electrically controlled element is connected to the optical plate, the electrically controlled element is configured to control a deflection of the optical plate, and when an incident angle of the first color light on the optical plate is greater than or equal to M degrees, the optical plate is configured to allow the first color light to pass through or configured to reflect the first color light; and
a wavelength conversion element, disposed on the transmission path of the first color light passing through the optical plate, wherein the wavelength conversion element is configured to convert the first color light into a converted light beam;
a light valve, disposed on a transmission path of the illumination beam and configured to convert the illumination beam into an image beam, wherein the illumination beam comprises at least one of the first color light, the converted light beam, the second color light, and the third color light; and
a projection lens, disposed on a transmission path of the image beam and configured to project the image beam out of the projection device.

19. The projection device according to claim 18, wherein the electrically controlled element comprises a first assembly and a second assembly, respectively disposed at two opposite ends of the optical plate, wherein the first assembly and the second assembly are configured to respectively receive different electrical characteristics.

20. The projection device according to claim 18, wherein the electrically controlled element comprises a first assembly and a second assembly, respectively disposed at two opposite ends of the optical plate, wherein the first assembly comprises a first coil and a first fixed magnet, the second assembly comprises a second coil and a second fixed magnet, the first coil and the second coil are configured to receive a current, such that one of a repulsive force and an attractive force is generated between the first coil and the first fixed magnet, and another one of the repulsive force and the attractive force is generated between the second coil and the second fixed magnet.

21. The projection device according to claim 18, wherein the light source module comprises:
a red light laser diode, a green light laser diode, and a blue light laser diode located in a same package, wherein the blue light laser diode is configured to emit the first color light, the red light laser diode is configured to emit the second color light, and the green light laser diode is configured to emit the third color light;
a reflecting element and a dichroic mirror, configured to guide the second color light and the third color light in the second direction; and
a guide assembly, configured to guide the first color light in the first direction.

22. The projection device according to claim 18, wherein the light source module comprises:
a red light laser diode, configured to emit the second color light;
a green light laser diode, configured to emit the third color light;
a blue light laser diode, configured to emit the first color light;
a dichroic mirror, configured to guide the second color light and the third color light in the second direction; and
a reflecting mirror, configured to reflect the first color light toward the first direction, wherein the red light laser diode, the green light laser diode, and the blue light laser diode are respectively located in different packages.
